(19) United States
(12) Patent Application Publication
(10) Pub. No.: US 2018/0084183 A1
(43) Pub. Date: Mar. 22, 2018

(54) IMAGING DEVICE FOR THE PRODUCTION OF ACCELERATED FILM

(71) Applicant: ENLAPS SAS, Meylan (FR)

(72) Inventors: Antoine Auberton-Herve, La Tronche (FR); Benoît Farinotte, Meylan (FR)

(21) Appl. No.: 15/563,837

(22) PCT Filed: Mar. 25, 2016
(86) PCT No.: PCT/FR2016/050693

§ 371 Date: Oct. 2, 2017

(30) Foreign Application Priority Data
Apr. 3, 2015 (FR) 1552914
Dec. 9, 2015 (FR) 1562087

(51) Int. Cl. H04N 5/232; H04N 5/77

(52) U.S. Cl. CPC H04N 5/23206; H04N 5/772; H04N 5/23241

(57) ABSTRACT

A standalone device for recording and transmitting images and/or control data includes least one image sensor associated with recording means, a unit for communicating images and/or control data to a remote server, a control unit for sequencing the recording and communication of images and/or control data, and a unit for generating and storing energy that is able to temporarily provide the operating power of the device after a predetermined point in time.

### CROSS-REFERENCE TO RELATED APPLICATIONS

This application is a national phase entry under 35 U.S.C. § 371 of International Patent Application PCT/FR2016/050693, filed Mar. 25, 2016, designating the United States of America and published as International Patent Publication WO 2016/156724 A1 on Oct. 6, 2016, which claims the benefit under Article 8 of the Patent Cooperation Treaty to French Patent Application Serial Nos. 1552914 filed Apr. 3, 2015 and U.S. Pat. No. 1,562,087 filed Dec. 9, 2015.

### TECHNICAL FIELD

A time-lapse film enables the observation of a phenomenon happening on a slow timescale. In order to make such a film, a succession of images of a target phenomenon are captured from a fixed or slowly moving location, each image capture being spaced out by a period of time chosen according to the dynamic behavior of the phenomenon.

### BACKGROUND

Thus, and by way of example, in order to film the construction of a building, a succession of daily images of the construction site is recorded, then increased to 50 images per second. Each second of the film therefore corresponds to 50 days of construction of the building site, and of the order of 10 seconds of film then enables the entire construction phase of the building site to be represented in an animated fashion over a short timescale.

These films may be aimed at promotional material or may allow the study of natural or industrial phenomena that are particularly slow and hence difficult to observe in a continuous manner.

The known devices for making a time-lapse film are generally derived from conventional cameras. In this respect, they are equipped with an image sensor associated with means for recording these images, such as, for example, a removable memory card. In certain cases, the image capture frequency may also be programmed.

However, these known devices are not very well adapted to the shooting of time-lapse films of slow phenomena that are therefore likely to last a very long time (several months or several years).

The reason for this is that these are devices whose energy autonomy is limited, which means that they need to be regularly accessed to recharge them. This is particularly problematic when the imaging device is positioned in a location that is difficult to access, which is generally the case in order to limit as far as possible the risk of it being stolen.

The constant access to the device is also necessary in order to be able to regularly save the recorded images, for example, accessing it to replace the removable memory card. It may also be necessary to access the device in order to modify its adjustments (image capture frequency, resolution of the image) or its orientation.

The known devices are not therefore autonomous in terms of energy and service.

Furthermore, they are not generally designed to be placed in an outside environment for a long period of time, exposed to the elements. This, therefore, limits them to being positioned in protected locations, which do not always correspond to locations favored for filming.

Furthermore, the devices remain susceptible to being stolen, even if they are positioned in a location that is difficult to access.

### BRIEF SUMMARY

The present disclosure is aimed at overcoming certain drawbacks of the prior art presented hereinabove. It is aimed, in particular, at providing an autonomous device for the recording and the transmission of images particularly well adapted to the production of a time-lapse film.

For this purpose, the disclosure relates, in its wider sense, to an autonomous device for the recording and the transmission of images and/or of control data comprising:
at least one image sensor associated with recording means;
a communications unit of the images and/or of the control data to a remote server;
a control unit for sequencing the recording and the communication of the images and/or of the control data; and
a unit for generating and for storing energy designed to temporarily supply the operating power for the autonomous device starting from a predetermined moment in time.

Thus, it is possible to temporarily activate the device at predetermined moments in time for image capture and/or for data acquisition, for transmitting/receiving information to/from a remote server. In this way, the use of the stored energy is preserved so as to constitute an autonomous device.

According to other advantageous and non-limiting features of the disclosure, taken alone or in combination:
the unit for generating and for storing energy comprises an energy generator, means for storing energy, a management module coupled to the generator and to the means for storing energy;
the energy generator comprises at least one photovoltaic cell;
the storage means comprise batteries, notably of the lithium polymer (LiPo) or lithium iron phosphate (LiFePO₄) type;
the management module comprises a switch controllable for temporarily supplying the operating power starting from the predetermined moment in time;
the communications unit comprises an antenna, a modem and a SIM card;
the autonomous device comprises a global positioning satellite (GPS) unit allowing the geographic location of the device to be determined;
the autonomous device comprises at least one extension connector; and
the device is included within a housing having a protection index greater than or equal to 54.

The disclosure also relates to a method for recording and for transmitting images and/or control data, at a predetermined moment in time, from an autonomous imaging device to a remote server, the method comprising the following steps:
upon the occurrence of the predetermined moment in time, measure the level of energy stored in a unit for generating and for storing energy of the device;
if the level of stored energy is higher than a first predetermined threshold:
   couple the unit for generating and for storing energy to at least a part of the autonomous device in order to supply the operating power; then
   carry out the acquisition of an image and/or of control data and its transfer into recording means of the autonomous device;
   transmit the image and/or the control data from the recording means to the remote server by means of a communications unit of the device, only if the level of stored energy is higher than a second predetermined energy threshold, higher than or equal to the first threshold; and
   decouple the unit for generating and for storing energy from the rest of the autonomous device.

According to other non-limiting features of this method of the disclosure, taken alone or in combination:
the method furthermore comprises a step for determining and for recording the next predetermined moment in time;
the method comprises, between the coupling and decoupling step, a step for receiving at least one piece of control data originating from the remote server via the communications unit; and
the method comprises, between the coupling and decoupling step, a step for determining the geographic position of the device and for blocking the device if this position goes beyond a predetermined position by a threshold distance.

Finally, the disclosure also relates to a control system for autonomous devices for recording and transmission of images and/or of control data, the system comprising a server in communication with a plurality of autonomous devices such as previously described.

### BRIEF DESCRIPTION OF THE DRAWINGS

The disclosure will be better understood in light of the description that follows of the particular and non-limiting embodiment of the disclosure with reference to the appended figures, amongst which:

FIGS. 1a through 1c show three overall views of a device according to the disclosure;

FIG. 2 shows a schematic diagram of the element composing an autonomous device according to the disclosure; and

FIG. 3 shows a flow diagram of one mode of operation of the device according to the disclosure.

### DETAILED DESCRIPTION

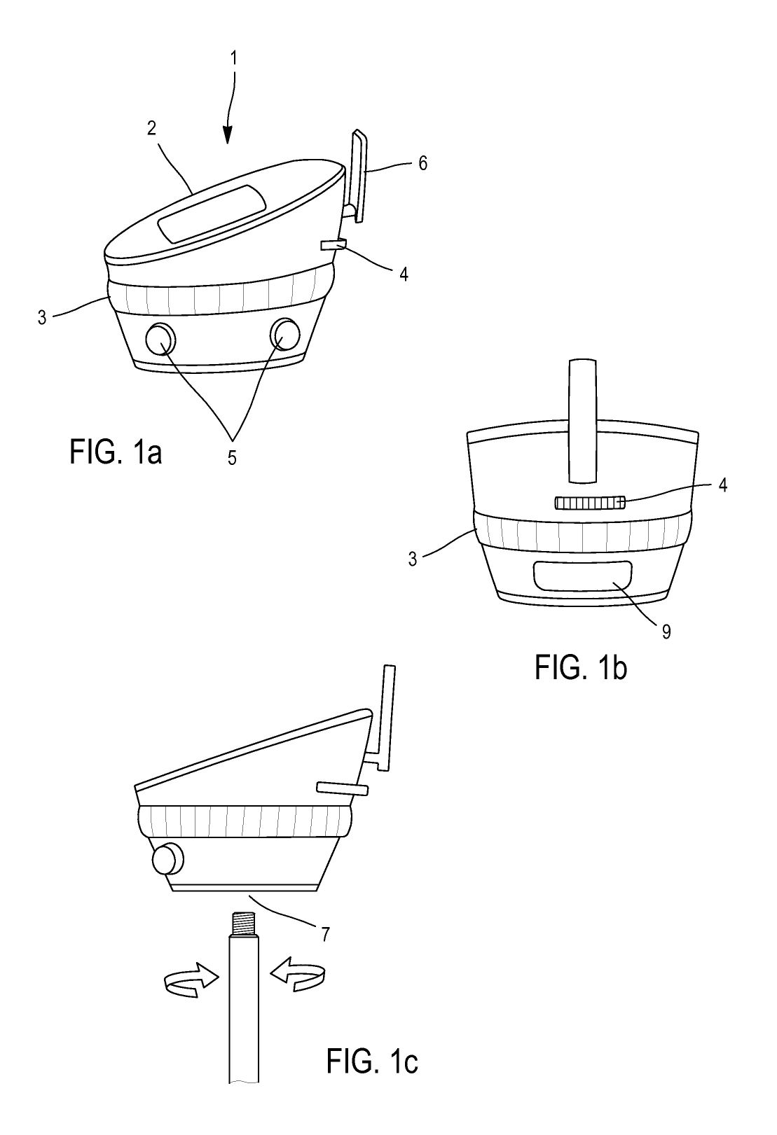

FIGS. 1a and 1b show overall views of an autonomous device 1 according to the disclosure.

This device is formed of a leak-tight housing protecting the most sensitive elements from its environment and able to exhibit, in this respect, a protection index greater than or equal to 54 (IP54).

At least one photovoltaic cell 2 is fixed on an inclined plane of an upper part of the housing, forming an energy generator for the autonomous device 1. Advantageously, the plane may be inclinable in a direction chosen in such a manner as to best orient the cell with respect to the path of the sun. This orientation is obtained by acting, for example, on a thumb-wheel 3 allowing the upper part of the housing to be rotated and by actuating a means for adjustment of the inclination 4 of the plane on which the photovoltaic cell 2 rests.

The housing is also equipped with at least one lens 5 that, in association with an image sensor inside of the housing, forms a camera whose function is to capture the images. Advantageously, the device is equipped with a plurality of cameras, each formed by a lens and an image sensor, thus allowing panoramic views to be composed by spatial juxtaposition of the images produced by each lens. In the case where the device 1 disposes of several lenses 5, it is also possible to select only that (or those) which is (are) the best oriented for the imaging envisioned.

Advantageously, the lens 5 and/or the image sensor forming the camera 10 may be fitted with a controllable optical and/or digital zoom, in order to best adjust the imaging frame.

For the applications that require it, the camera may be designed to carry out the acquisition of images within a given spectral band, such as, for example, the infrared. Filters or more complex processing operations may be applied to the recorded images, for example, using digital means, which will be presented hereinbelow.

In any case, the mobility of the upper part of the housing, on which the cell 2 is positioned, with respect to the lower part of the housing, on which the lens 5 is positioned, allows the orientation of the cell to be dissociated from the image capture orientation.

In the example shown in FIG. 1, an antenna 6, forming a part of a communications unit, protrudes from the housing in order to place the device under favorable conditions for transmission and/or reception. Where the housing disposes of a GPS unit, the antenna 6 may also be connected to this unit.

The housing of the autonomous device 1 is also equipped with attachment means 7. This may be a screw attachment located under the housing as is shown in FIG. 1c.

The housing is also fitted with a removable cover 9 providing a protection for a plurality of extension connectors 19 for, by way of example, the insertion of a memory card, a USB link or the connection of an external power supply to the device 1. This external power supply is not generally intended to be used during the normal operation of the autonomous device 1, but can be useful for its maintenance, for example. The extension connector may be used for the connection of peripheral devices, such as sensors (anemometers, remote temperature probe, air quality measurement station) allowing a set of information on the near environment of the device to be collected and transmitted.

The removable cover 9 can also provide a protection for other elements such as switches or buttons for testing or resetting the autonomous device 1.

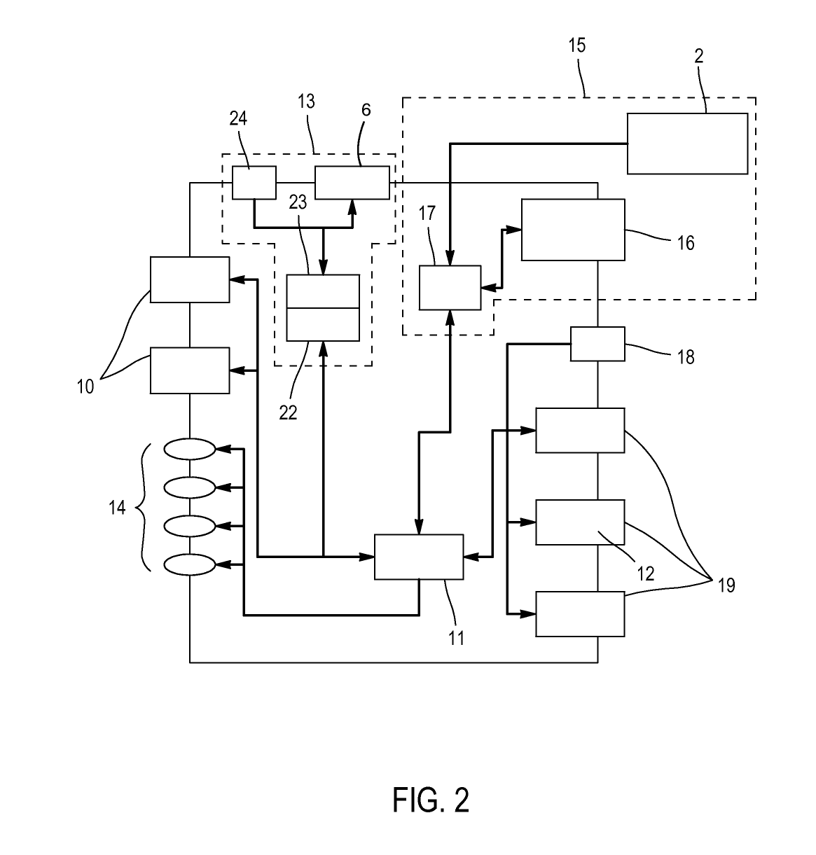

FIG. 2 shows a schematic diagram of the elements composing an autonomous device according to the disclosure.

As previously described, the device comprises at least one camera 10, composed of a lens 5 and an image sensor.

The image sensor is associated with means for recording these images. This may be a programmable non-volatile memory with a sufficient capacity for storing a predetermined number of images with a given resolution. The recording means may also be used for the storage of the control data for the autonomous device 1, or of its control software, executed by a microcontroller or a microprocessor of a control unit 11. The recording means may, at least in part, be constituted by a removable memory card 12, of the SD type, in certain cases allowing access to the recorded images. For this purpose, and as has been described in relation with FIGS. 1a through 1c, the housing may be equipped with an extension connector 9 allowing the insertion of such a memory card 12.

The device also comprises a unit 13 for communicating the images and/or control data to a remote server S. The communications unit comprises a modem 23 (for example, GSM or WiFi), an antenna 6 and a SIM card 24. Optionally, it may comprise a GPS unit 22. The communications unit 13 may also comprise short-distance communications means (BLUETOOTH®, ZIGBEE®, etc.) allowing a local connectivity with the housing, without the need to handle it, for example, in order to provide the same functions as those permitted by the USB extension connector 19 previously described.

This main aim of the communications unit 13 is to establish an uplink with this server S in order to transmit to it images stored in the recording means. Once the images have been transmitted to and stored in this server, they may be deleted from these means. This unit is also aimed at establishing an uplink (transmission) and downlink (reception) to/from the server for exchanging the data for the control of the autonomous device 1. Control data is understood to mean all of the data allowing either the configuration of the device or forming state data of this device or of its environment.

By virtue of the communication being established between the remote server S and the communications unit 13, it is therefore possible for a user to access the images stored on the server S, in order to download them and use them to make a film, to know the state of the device 1 and of its environment (using the control data uploaded to the server S), and also to configure it.

The autonomous device 1 also comprises a control unit 11 providing the sequencing of the image capture steps, the potential processing of the images, the recording of the images and the transmission/reception of these images and/or of the control data. More generally, the control unit 11 ensures the correct operation of the device when the latter is supplied with power, and the coordination of the exchanges with any peripheral devices.

The control unit is therefore configured to allow the processing of the recorded images, in cooperation with a processing program disposed in the recording means of the device. This processing may correspond to the application of filters, or to the correction of the sharpness of an image, or even to the detection of objects and/or of faces. The detection information may be integrated into the control information uploaded to the server, in order to communicate the presence of an object and/or of a face.

Optionally, the device may be equipped with one or more indicator lights 14, for example, of the LED type, allowing the internal state of the device 1 to be indicated on a face of the housing. Also optionally, the autonomous device 1 may comprise an integrated temperature probe 18 allowing the measurement of the outside temperature.

The autonomous device 1 furthermore comprises a unit for generating and for storing energy 15 in order to supply autonomously the electrical power needed for its operation. This unit 15 is composed of an energy generator 2, such as the photovoltaic cell described with reference to FIGS. 1a through 1c, means for storing energy 16 such as a battery, for example, a battery of the LiPo or LiFePo₄ type, and of a management module 17 coupled to the storage means and to the generator.

Preferably, the battery is chosen so as to exhibit a good efficiency (low loss) even when it is exposed to high temperatures or significant variations in temperature. This may be a battery of the LiFePo₄ type. It is thus ensured that the autonomy is not degraded when the autonomous device 1 is located outside for a long period.

The function of the management module 17 is first to couple the energy generator 2 to the storage means 16 in order to enable it to be charged. This module 17 also provides all the power management functions for the autonomous device 1 and disposes of information on the storage means 16 (for example, the level of charge of the battery or its temperature) and on the generator 2 (for example, the level of sunshine determined from the instantaneous power produced by the generator). This data furthermore constitutes one example of control data for the device 1 that can be uploaded to the server S by the communications unit 13.

The management module 17 is permanently electrically powered by the energy generator 2 and/or the storage means 16, which renders the generation and storage unit completely independent from this point of view of the rest of the device. The management module may dispose of a microcontroller or of a microprocessor, and of its own information storage means allowing it to execute its own operation software independently of the control unit 11.

According to the disclosure, and in order to supply just the electrical power needed, the unit for generating and for storing energy 17 is designed to temporarily supply the operating power for the device starting from a predetermined moment in time. The term “temporarily” is understood to mean that this unit 17, by means of the management module, is selectively coupled to or decoupled from the other elements of the device, such as the control unit 11, the communications unit 13, the image sensor and the recording means. The term “predetermined moment in time” means a moment in time chosen in advance, preprogrammed. Accordingly, “just the right amount” of energy can be supplied in order to ensure the proper operation of the device.

The reason for this is that, since the device is designed to capture images spaced out over time, it is not imperative to keep the whole of the device continuously powered. By limiting the duration of the power supply to a limited period of time, starting from a chosen moment in time, it is possible to limit the dimensions of the generation and storage unit to just what is necessary in order to be able to form a compact, easily usable, device. Thus, the autonomous device 1 may have sufficiently small dimensions so as to be contained within a volume defined by a cube of 20 cm on a side. Its power consumption may be reduced to less than 10 Wh per day, or less than 7 Wh per day or even 5 Wh per day.

Advantageously, the power management module 17 is equipped with a controllable switch allowing the energy generation and storage unit 15 to be coupled to the rest of the device 1 at a predetermined moment in time (in other words at least to the control unit 11, to the communications unit 13 and to the image sensor associated with the recording means). For this purpose, the management module 17 or the controllable switch is equipped with a real-time clock, for example, of the RTC type (according to the acronym for “Real Time Clock”), as is well known per se.

Optionally, the housing may also be equipped with a presence and/or motion sensor in order to be able to receive information on activity in the near environment of the housing. This information may, for example, be used by the control unit 11 and/or the power management module 17 in order to trigger the re-activation of the unit and to allow an image to be captured or to accelerate the image capture rate. The re-activation of the unit may also be followed by the sending to the server of the information on presence and/or on movement close to the unit, for example, by incorporating this information into the control information for the unit.

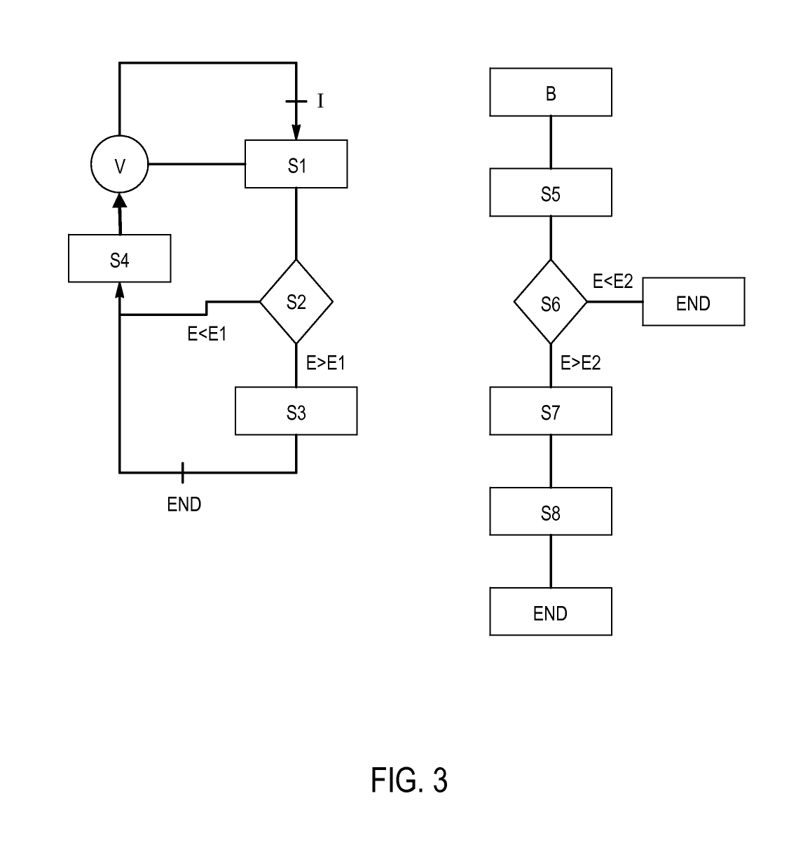

With reference to FIG. 3, a method is presented for recording and transmitting images and/or control data, at a predetermined moment in time, from the autonomous imaging device 1 to a remote server S.

In the example that will be detailed, it is considered that the device is positioned so as to capture a succession of images of a target phenomenon. It is also considered that the device is initially in a standby state V, in other words that only the generation and storage unit 15 is supplied with power and that all the other elements of the device 1 are inactive.

The predetermined moment in time for image capture is stored in an information storage means of the management module 17 or of the clock. The moment in time is identified, for example, by comparing the time indicated by the clock of the management module with the predetermined and stored time of the next image capture or activation phase of the device.

This re-activation event I, which may be generated in the form of an interrupt originating from the clock (or else from a signal originating from the presence and/or motion sensor) and sent to a microcontroller of the management unit 17, leads to engaging the execution of a program comprising a first step S1 for determining the level of energy stored in the generation and storage unit 15.

During a step S2, if the stored energy level E is sufficient, in other words if it is higher than a first predetermined threshold E1, the controllable switch is triggered and causes, during a step S3, the coupling of the generation and storage unit 17 to at least a part of the rest of the device, in order to supply the operating power. If this is not the case, in other words if the energy level E is lower than the first predetermined energy threshold E1, the coupling is not made and the device goes back into standby state V, after having determined and stored the next predetermined activation time, during a step S4.

The part of the device coupled to the unit 17 may consist of the control unit, the image sensor and the recording means. If the activation of the device is only aimed at the data acquisition and its recording, it is not necessary to couple the image sensors.

The microcontroller/microprocessor of the control unit 11 then engages its start-up program B, and in a first step S5 carries out the acquisition of an image and/or of control data, then its transfer into the recording means.

In one variant, the acquisition of an image is only carried out if the light intensity is higher than a given threshold. The value of the light intensity may be estimated according to the power level supplied by the photovoltaic cell 2.

During a following step S6, it is determined whether the stored energy level E measured in the step S2 is less than a second predetermined threshold E2.

In the case where the stored energy level is lower than the second predetermined threshold E2, it is preferable at this time to decouple the storage and power management unit from the rest of the device and go back to standby mode V until the occurrence of the next predetermined activation time, determined during the step S4. For this purpose, the control unit 11 can send a signal END to the management module 17 indicating the end of its activity.

The demand on the limited quantity of available energy for image and/or control data transmission is thus avoided. These images and/or data are still stored in the device and remain available for transmission during the next re-activation.

This situation where the available energy E is limited may arise, for example, after a succession of dull days, which have not allowed the batteries to charge up sufficiently. The subsequent rise of the level of charge of the battery will allow the transmission of the images and/or of the control data at a later time.

In the case where the energy level E is very insufficient, lower than the first predetermined threshold E1, in this case, it is preferable not to re-activate the device at all and to maintain the minimum of remaining energy in order to keep the operation of the management module 17.

The step S4 for determination and for recording of the next predetermined moment in time may consist of a simple calculation of the next re-activation time based on certain control data (for example, using the chosen image capture frequency) or may comprise the execution of a more complex determination algorithm, aimed at estimating (for example, based on the state of charge of the battery and on the amount of sunshine) the next moment in time where the level of energy stored E will be higher than the threshold E2. By way of example, the algorithm may take historical information on the amount of sunshine into account (using a meteorological database or data collected by the unit itself, or data collected by geographically nearby units) in order to estimate the next re-activation date allowing control information and/or stored images to be uploaded to the server, or allowing an image capture sequence to be engaged. In a second example, the algorithm may use almanac data stored in the recording means in order to establish the next predetermined activation time allowing the image of a natural phenomenon to be captured, such as a sunrise or sunset.

If the stored energy level E measured in the preliminary step S2 is higher than the second predetermined threshold E2, then the unit for generating and for storing energy may be coupled to all the elements of the device, and notably to the communications unit 13. During a step S7, as a complement to the steps already described, the transmission of the image or images and/or of the control data from the recording means to the remote server S may be carried out. Once transmitted, the images and/or data may be deleted from the recording means in order to free up some space. They may also be saved for archiving or maintenance reasons.

According to one advantageous feature of the method and as long as the stored energy level E is higher than the threshold E2, the transmission of images and/or of control data continues until all the images and/or control data stored in the recording means have been transmitted to the server. If this level E were to fall below the threshold E2, the transmission would then be interrupted, and the transfer of the remaining information postponed until the next active phase.

Generally speaking, the rule for sending images, in other words the choice of the quantity of images and/or of data uploaded during an active sequence, can be based on additional information such as:
The quality of the link to the server, a good link (in terms of data rate) favoring a short connection time and hence an optimum use of the energy available.
Instantaneous power produced by the generator, indicating strong sunshine, where this energy may be sufficient for performing the required operations without excessively draining the stored energy.

The control data transmitted may include the identifier of the autonomous device 1, the level of charge of the battery, together with information on current/voltage and temperature of the battery, the time and the date on the clock, the environmental data captured by the internal sensors (temperature probe) or data coming from the peripherals associated with the device via the extension connector, etc.

Prior to, simultaneously with or following the transmission, control data coming from the server S may be received by the communications unit and stored in the recording means.

The control data may define the parameters of the device (time of the next image capture or captures, image capture frequency, resolution of the image, choice of the camera, light intensity limiting threshold below which the image capture is not carried out, list of the control data to be transmitted) and, in this case, the control unit defines the parameters of the element of the device in question, during a parametrization step S8.

In one advantageous configuration, the autonomous device 1 is equipped with a GPS unit 22, for example, included in the communications unit 13. This GPS unit 22, for example, a GPS module, allows the geographic position of the device to be determined. This data may form part of the control data transmitted to the server. Other control data stored in the recording means may also specify the initial or expected position of the device. One function of the GPS unit 22 may also be the precise updating of the date and of the time of the clock of the autonomous device 1, situated, for example, within the management module 17.

The method of the disclosure may also comprise, for example, during the step S7, the comparison between the real position of the device (supplied by the GPS unit) and its expected position (stored in the recording means, and preferably in a non-volatile memory of the control unit 11). In the case of an excessive difference beyond a certain distance, the control unit may place the device in a blocked, non-operational mode.

This switching into a blocked mode may be preceded by sending a message (to the server or by SMS directly to the user) in order to inform the user of the suspect displacement of the device, via the communications unit 13.

In one variant, this functionality is invoked as soon as the energy level E is higher than the first predetermined threshold E1. It may therefore require a prior step for coupling the unit for generating and for storing energy 15 to the communications unit 13, as soon as the energy level E is higher than the first predetermined threshold E1.

It is thus possible to prevent the use of the autonomous device 1 in the case where it had been stolen, which therefore limits the interest of such a theft. It also allows the informed user to arrange the blocking of the SIM card of the communications unit 13.

The unblocking of the device may be carried out by connecting the latter, for example, via its USB or BLUETOOTH® link, to a maintenance system (a computer or a tablet, for example) allowing its connection with the server without using the communications unit 13 and its resetting into operational mode after identification of the user.

Finally, the disclosure also relates to a control system for the autonomous devices that have just been described, this system comprising a server in communication with a plurality of these devices.

As described, the server allows a user, connected via a computer, a tablet or else a telephone, to take control of a device 1 in order to configure it, for example, at a desired captured image.

A prior step for configuration and for secure pairing between an autonomous device 1 and an identifier of the user on the server S may be necessary. Each device 1 disposes of a unique device identifier, stored in a non-volatile part of the recording means, for example, within the control unit 11. Preferably, the identifier of the user is not held in the device, the association between the identifier of the device and the identifier of the user being held in a highly secure part of the server S.

Advantageously, the server offers a user a plurality of predefined configurations, in order to facilitate taking control of the device. The choice of one of these predefined configurations results in the sending of control information providing the chosen function.

According to a first example of predefined configuration, the device 1 is configured to allow a maximum number of images to be captured during a given period. It is thus possible for the server, using the information uploaded by the autonomous device 1, to determine the optimum frequency of use of this device without the latter starting to lack energy. The server may, in this case, suggest the optimum configuration parameters and/or transmit these parameters to the autonomous device during a future connection.

According to a second example of predefined configuration, the device 1 is configured so as to allow the imaging of a predictable natural phenomenon (sunset or sunrise, for example): the image capture period may be determined by the server on the basis of almanac data and of the GPS position of the device (in order to take into account any masking effects), and during this image capture period, the device may carry out the acquisition of 5 to 10 images per second.

According to a third example of predefined configuration, well suited to the production of a time-lapse film of a construction site, the frequency of image capture is adjusted (by increasing it or slowing it down) depending on the quantity of energy available in the device and taking care to avoid using up this energy, which would lead to a long period in standby mode for the device (with no image capture).

According to one advantageous feature, the autonomous device is equipped with a test button (mainly used during the installation or maintenance), which enables the forced upload to the remote server S of a captured image and/or of the control data. The test button may also allow the autonomous device 1 to be forced to accept new parameters, placed on the server S. This button allows the correct operation of the system to be validated: network coverage, camera alignment and framing. This button is only functional after the pairing of the device with a user and hence after the activation of the SIM card 24 of the communications unit 13.

The server also allows the storage of the images and of the control data received by the device. It may also supply the means for putting together a time-lapse film starting from the recovered images and for its publishing to make it available to a public, limited or otherwise.

It goes without saying that the disclosure is not limited to the example described and variant embodiments may be applied to it without straying from the scope of the disclosure, such as the latter is defined by the claims that follow.

Thus, although the acquisition of one image at each re-activation of the device 1 has been described, the acquisition of a series of images or even of short films may be carried out.

Furthermore, one and the same device may allow the acquisition of several series of images that are intended to be assembled into separate accelerated films: these may be images coming from different cameras (and hence from different viewing angles) if the device 1 is equipped with several cameras, or else a series of images each taken at specific moments in time (in the morning and evening, for example). In this configuration, and in order to pre-empt situations where the energy available in the unit might be insufficient to enable the acquisition of all the images of each series, one of the series could be identified as higher priority and could be subjected to a higher priority processing, where the image captures and/or the uploading to the server of the images associated with the other series may be carried out in a non-systematic manner.

Finally, although it has been indicated that the device comprised a control unit 11 and a management module 17 each equipped with a microprocessor or with a microcontroller, in one variant embodiment, it is possible to only employ a single microprocessor or microcontroller providing all the functions of this unit and of this module. This is notably the case if this microprocessor or microcontroller exhibits a very limited energy consumption in itself.

1.-14. (canceled)

15. An autonomous device for recording and transmission of images and/or control data, comprising:
at least one image sensor associated with a memory device for recording images obtained from the at least one image sensor;
a communications unit for communicating images and/or control data to a remote server;
a control unit for controlling the recording and the communication of the images and/or of the control data; and
a power unit for generating and storing energy and configured to temporarily supply operating power for the autonomous device starting from a predetermined moment in time.

16. The autonomous device of claim 15, wherein the power unit further comprises:
an energy generator;
means for storing energy; and
a management module permanently coupled to the energy generator and to the means for storing energy.

17. The autonomous device of claim 16, wherein the energy generator comprises at least one photovoltaic cell.

18. The autonomous device of claim 16, wherein the means for storing energy comprises at least one battery.

19. The autonomous device of claim 18, wherein the at least one battery comprises a LiPo battery or a LiFePO₄ battery.

20. The autonomous device of claim 16, wherein the management module comprises a controllable switch for temporarily supplying the operating power for the autonomous device starting from the predetermined moment in time.

21. The autonomous device of claim 16, wherein the communications unit comprises an antenna, a modem, and a SIM card.

22. The autonomous device of claim 16, further comprising a GPS unit allowing a geographic location of the device to be determined.

23. The autonomous device of claim 15, wherein the communications unit comprises an antenna, a modem, and a SIM card.

24. The autonomous device of claim 15, further comprising a GPS unit allowing a geographic location of the device to be determined.

25. The autonomous device of claim 15, further comprising at least one extension connector.

26. The autonomous device of claim 15, further comprising a housing having a protection index greater than or equal to fifty four (54).

27. A method for recording and for transmitting images and/or control data from an autonomous imaging device to a remote server at a predetermined moment in time, the method comprising the following steps:
upon the occurrence of the predetermined moment in time, measuring a level of energy stored in a power unit for generating and storing energy for the autonomous device;
if the level of energy stored is higher than a first predetermined energy threshold, then:
coupling the power unit to at least a part of the autonomous device in order to supply operating power to the at least a part of the autonomous device;
after the power unit to at least a part of the autonomous device, acquiring an image and/or control data and recording the acquired image and/or control data in a memory device of the autonomous device; and
transmitting the image and/or control data from the memory device to the remote server using a communications unit of the device only if the level of energy stored is higher than a second predetermined energy threshold, the second predetermined energy threshold being higher than or equal to the first predetermined energy threshold; and
decoupling the power unit from the rest of the autonomous device.

28. The method of claim 27, further comprising a step of determining and recording of a next predetermined moment in time.

29. The method of claim 27, further comprising, after coupling the power unit to at least a part of the autonomous device and before decoupling the power unit from the rest of the autonomous device, receiving at least one piece of control data originating from the remote server via the communications unit.

30. The method of claim 27, further comprising, after coupling the power unit to at least a part of the autonomous device and before decoupling the power unit from the rest of the autonomous device, determining a geographic position of the autonomous device and blocking the autonomous device if the position is beyond a predetermined position by a threshold distance.

31. A system for controlling autonomous devices for recording and for transmitting images and/or control data, the system comprising a server in communication with a plurality of autonomous devices, each autonomous device of the plurality comprising:
at least one image sensor associated with a memory device for recording images obtained from the at least one image sensor;
a communications unit for communicating images and/or control data to a remote server;
a control unit for controlling the recording and the communication of the images and/or of the control data; and
a power unit for generating and storing energy and configured to temporarily supply operating power for the autonomous device starting from a predetermined moment in time.
